(19) United States
(12) Patent Application Publication
(10) Pub. No.: US 2009/0102805 A1
(43) Pub. Date: Apr. 23, 2009

(54) Three-dimensional object simulation using audio, visual, and tactile feedback

(75) Inventors: Erik Meijer, Mercer Island, WA (US); Umut Aley, Redmond, WA (US); Sinan Ussakali, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/975,321

(22) Filed: Oct. 18, 2007

(51) Int. Cl. G06F 3/041

(52) U.S. Cl. 345/173

(57) ABSTRACT

A multi-sensory experience is provided to a user of a device that has a touch screen through an arrangement in which audio, visual, and tactile feedback is utilized to create a sensation that the user is interacting with a physically-embodied, three-dimensional (“3-D”) object. Motion having a particular magnitude, duration, or direction is imparted to the touch screen so that the user may locate objects displayed on the touch screen by feel. In an illustrative example, when combined with sound and visual effects such as animation, the tactile feedback creates a perception that a button on the touch screen moves when it is pressed by the user like a real, physically-embodied button. The button changes its appearance, an audible “click” is played by the device, and the touch screen provides a tactile feedback force against the user's finger.

### BACKGROUND

Touch-sensitive display screens have become increasingly common as an alternative to traditional keyboards and other human-machine interfaces (“HMI”) to receive data entry or other input from a user. Touch screens are used in a variety of devices including both portable and fixed location devices. Portable devices with touch screens commonly include, for example, mobile phones, personal digital assistants (“PDAs”), and personal media players that play music and video. Devices fixed in location that use touch screens commonly include, for example, those used in vehicles, point-of-sale (“POS”) terminals, and equipment used in medical and industrial applications.

Touch screens can serve both to display output from the computing device to the user and receive input from the user. In some cases, the user “writes” with a stylus on the screen, and the writing is transformed into input to the computing device. In other cases, the user's input options are displayed, for example, as control, navigation, or object icons on the screen. When the user selects an input option by touching the associated icon on the screen with a stylus or finger, the computing device senses the location of the touch and sends a message to the application or utility that presented the icon.

To enter text, a “virtual keyboard,” typically a set of icons that look like the keycaps of a conventional physically-embodied keyboard is displayed on the touch-screen. The user then “types” by successively touching areas of the touch screen associated with specific keycap icons. Some devices are configured to emit an audible click or other sound to provide feedback to the user when a key or icon is actuated. Other devices may be configured to change the appearance of the key or icon to provide a visual cue to the user when it gets pressed.

While current touch screens work well in most applications, they are not well suited for “blind” data entry or touch-typing where the user wishes to make inputs without using the sense of sight to find and use the icons or keys on the touch screen. In addition, in some environments it is not always possible to rely on visual and auditory cues to provide feedback. For example, sometimes touch screens are operated in direct sunlight which can make them difficult to see or in a noisy environment where it can be difficult to hear. And in an automobile, it may not be safe for the driver to look away from the road when operating the touch screen.

Traditional HMI devices typically enable operation by feel. For example, with a physical keyboard, the user can feel individual keys. And in some cases, several keys such as the “F” and “J” have small raised dots or bars that enable the user to orient their fingers over the “home” row of keys by feel without having to look at the keys. By comparison current touch screens, even those which provide audible or visual feedback when buttons or keys are pressed, do not enable users to locate and operate icons or keys by feel.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A multi-sensory experience is provided to a user of a device that has a touch screen through an arrangement in which audio, visual, and tactile feedback is utilized to create a sensation that the user is interacting with a physically-embodied, three-dimensional (“3-D”) object. Motion having a particular magnitude, duration, or direction is imparted to the touch screen so that the user may locate objects displayed on the touch screen by feel. Such objects can include icons representing controls or files, keycaps in a virtual keyboard, or other elements that are used to provide an experience or feature for the user. For example, when combined with sound, and visual effects such as animation, the tactile feedback creates a perception that a button on the touch screen moves when it is pressed by the user just like a real, physically-embodied button. The button changes its appearance, an audible “click” is played by the device, and the touch screen moves (e.g., vibrates) to provide a tactile feedback force against the user's finger or stylus.

In various illustrative examples, one or more motion actuators such as vibration-producing motors are fixedly coupled to a portable device having an integrated touch screen. In applications where the device is typically in a fixed location, such as with a POS terminal, the motion actuators may be attached to a movable touch screen. The motion actuators generate tactile feedback forces that can vary in magnitude, duration, and intensity in response to user interaction with objects displayed on the touch screen so that a variety of distinctive touch experiences can be generated to simulate different interactions with objects on the touch screen as if they had three dimensions. Thus, the edge of a keycap in a virtual keyboard will feel differently from the center of the keycap when it is pressed to actuate it. Such differentiation of touch effects can advantageously enable a user to make inputs to the touch screen by feel without the need to rely on visual cues.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative portable computing environment in which a user interacts with a device using a touch screen;

FIG. 2 shows an illustrative touch screen that supports user interaction through icons and a virtual keyboard;

FIGS. 3A and 3B show an alternative illustrative form-factor for a portable computing device which uses physical controls to supplement the controls provided by the touch screen;

FIG. 4A shows an illustrative button icon that is arranged to appear to have a dimension of depth when in its un-actuated state;

FIG. 4B shows the illustrative button icon as it appears in its actuated state;

FIG. 5A shows an illustrative keycap that is arranged to appear to have a dimension of depth when in its un-actuated state;

FIG. 5B shows the illustrative keycap as it appears in its actuated state;

FIG. 6 shows an illustrative portable computing device that provides a combination of tactile, audio, and visual feedback to a user when a keycap is actuated using the device's touch screen;

FIGS. 7A and 7B show respective front and orthogonal views of an illustrative vibration motor and rotating eccentric weight;

FIG. 7C is a top view of a vibration unit as mounted in a device shown in a cutaway view;

FIG. 7D is an orthogonal view of a vibration unit as mounted to a touch screen in a POS terminal;

FIGS. 8A and 8B show respective top and side views of an illustrative virtual keycap for which a tactile feedback force profile is applied in response to touch to impart the perception to a user that the keycap has a depth dimension;

FIG. 9 shows an illustrative application of 3-D object simulation using audio, visual, and tactile feedback;

FIG. 10 shows another illustrative application of 3-D object simulation using audio, visual, and tactile feedback; and

FIG. 11 shows an illustrative architecture for implementing 3-D object simulation using audio, visual, and tactile feedback.

Like reference numerals indicate like elements in the drawings.

### DETAILED DESCRIPTION

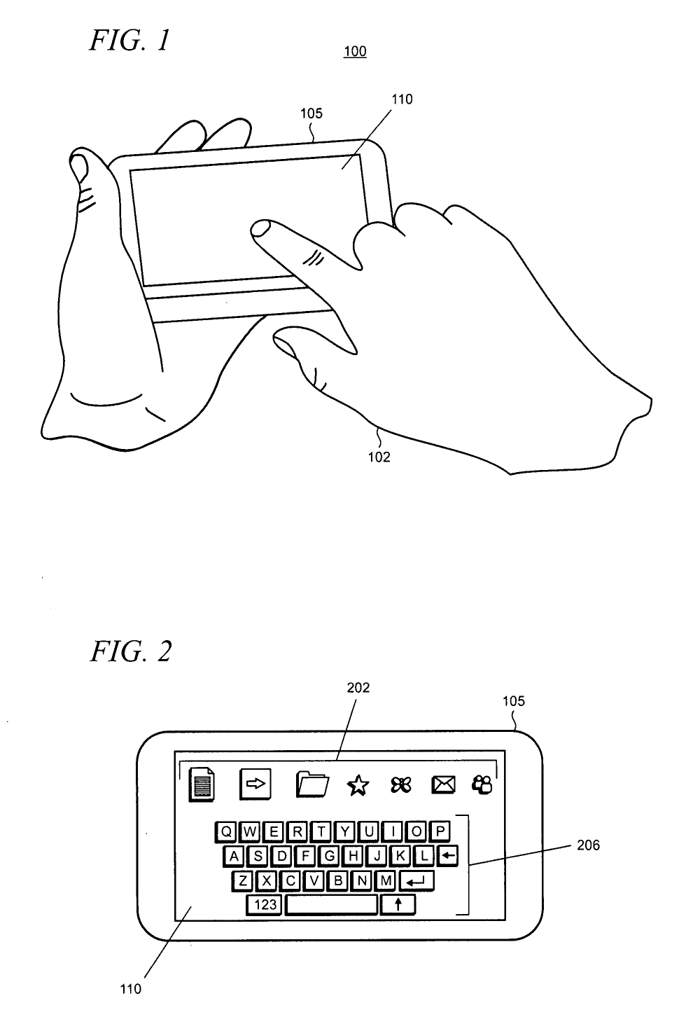

FIG. 1 shows an illustrative portable computing environment 100 in which a user 102 interacts with a device 105 using a touch screen 110 which facilitates application of the present three-dimensional (“3-D”) object simulation using audio, visual, and tactile feedback. Device 105, as shown in FIG. 1, is commonly configured as a portable computing platform or information appliance such as a mobile phone, smart phone, PDA, ultra-mobile PC (personal computer), handheld game device, personal media player, and the like. Typically, the touch screen 110 is made up of a touch-sensor component that is constructed over a display component. The display component displays images in a manner similar to that of a typical monitor on a PC or laptop computer. In many applications, the device 105 will use a liquid crystal display (“LCD”) due to its light weight, thinness, and low cost. However, in alternative applications, other conventional display technologies may be utilized including, for example, cathode ray tubes (“CRTs”), plasma-screens, and electro-luminescent screens.

The touch sensor component sits on top of the display component. The touch sensor is transparent so that the display may be seen through it. Many different types of touch sensor technologies are known and may be applied as required to meet the needs of a particular implementation. These include resistive, capacitive, near field, optical imaging, strain gauge, dispersive signal, acoustic pulse recognition, infrared, and surface acoustic wave technologies, among others. Some current touch screens can discriminate among multiple, simultaneous touch points and/or are pressure-sensitive. Interaction with the touch screen 110 is typically accomplished using fingers or thumbs, or for non-capacitive type touch sensors, a stylus may also be used.

While a portable form-factor for device 105 is shown in FIG. 1, the present arrangement is alternatively usable in fixed applications where touch screens are used. These applications include, for example, automatic teller machines (“ATMs”), point-of-sale (“POS”) terminals, or self-service kiosks and the like such as those used by airlines, banks, restaurants, and retail establishments to enable users to make inquiries, perform self-served check-outs, or complete other types of transactions. Industrial, medical, and other applications are also contemplated where touch screens are used, for example, to control machines or equipment, place orders, manage inventory, etc. Touch screens are also becoming more common in automobiles to control subsystems such as heating, ventilation and air conditioning (“HVAC”), entertainment, and navigation. The new surface computer products, notably Microsoft Surface™ by Microsoft Corporation, may also be adaptable for use with the present 3-D object simulation.

It is also emphasized that the present arrangement for 3-D object simulation is not necessarily limited to the consumer, business, medical, and industrial applications listed above. A wide range of uses and applications may be supported including, for example, military, security, and law enforcement scenarios for which robust and feature-rich user interfaces are typically required. In these demanding environments, more positive interaction and control for devices and systems is enabled by the enhanced correlation and disambiguation of objects displayed on a touch screen provided to the user using a combination of audio, visual and tactile feedback.

FIG. 2 shows an illustrative touch screen 110 that supports user interaction through icons 202 and a virtual keyboard 206. Icons 202 are representative of those that are commonly displayed on the touch screen 110 to facilitate user control, input, or navigation. Icons 202 may also represent content such as files, documents, pictures, music, etc., that is stored or otherwise available (e.g., through a network or other connection) on the device 105. The virtual keyboard 206 includes a plurality of icons that represent keycaps of a conventional keyboard, as shown. Touch screen 110 will typically provide other functionalities such as a display area or editing window (not shown in FIG. 2) which shows the characters (i.e., letters, numbers, symbols) being typed by the user on the virtual keyboard 206.

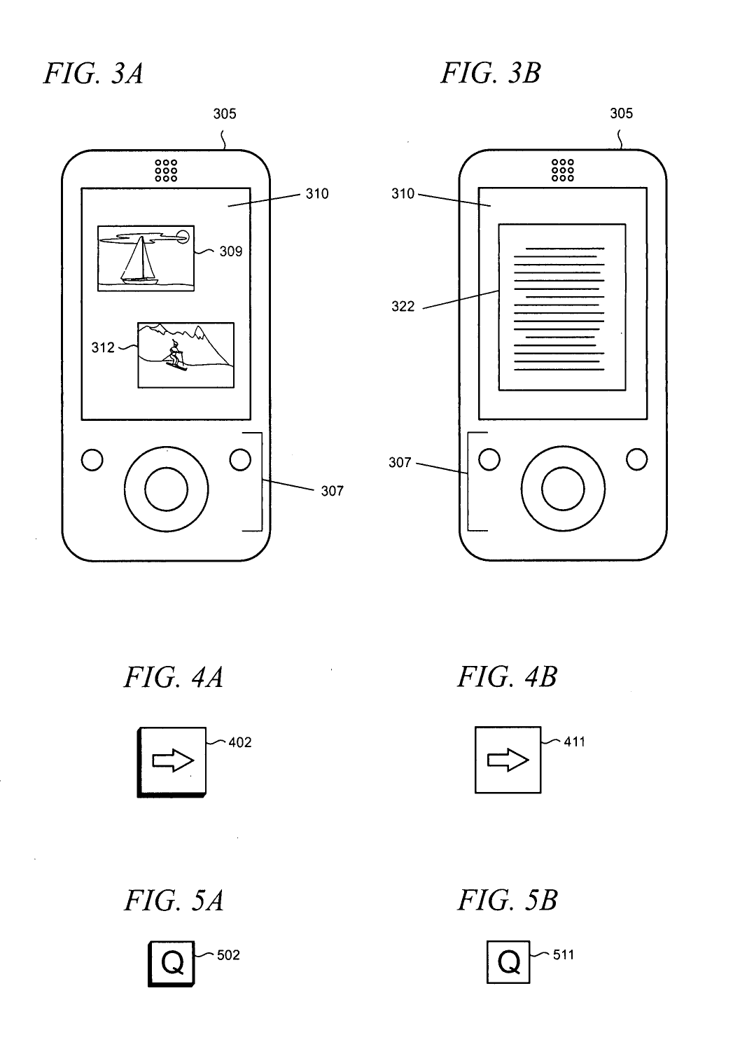

FIGS. 3A and 3B show an alternative illustrative form-factor for a portable computing device 305 which uses physical controls 307 (e.g., buttons and the like) to supplement the user interface provided by the touch screen 310. In this example as shown in FIG. 3A, several pieces of media content (indicated by reference numerals 309 and 312), which can represent photographs or video, for example, are displayable on the touch screen 310. FIG. 3B shows a page of an exemplary document 322 which is displayable on the touch screen 310.

As shown in FIGS. 3A and 3B, device 305 orients the touch screen 310 in “portrait” mode where the long dimension of the touch screen 310 is oriented in an up-and-down direction. However, some portable computing devices usable with the present arrangement for 3-D object simulation may be arranged to orient the touch screen in a landscape mode, while others may be switchable between portrait and landscape modes, either via user selection or automatically.

FIG. 4A shows an illustrative button icon 402 that is arranged to appear to have a dimension of depth. Visual effects such as drop shadows, perspective, and color may be applied to a 2-D element displayed on a touch screen (e.g., touch screen 110 or 310 in FIGS. 1 and 3, respectively) to give it an appearance of having 3-D form. In this example, the visual effect is applied to the button icon 402 when it is in an un-actuated state (i.e., not having been operated or “pushed” by a user) so that its top surface appears to be located above the plane of the touch screen just as a real button might extend from a surface of a portable computing device.

FIG. 4B shows a button icon 411 as it would appear when actuated by a user by touching the button icon with a finger or stylus. As shown, the visual effect is removed (or alternatively, reduced in effect or applied differently) so that the button icon 402 appears to be lower in height when pushed. In those applications where pressure-sensitivity is employed with the touch screen, the visual effect may be reduced in proportion, for example, to the amount of pressure applied. In this way, the button icon 411 can appear to go down further as the user presses harder on the touch screen 110.

FIGS. 5A and 5B show the application of similar visual effects as described above in the text accompanying FIGS. 4A and 4B when applied to an illustrative keycap. FIG. 5A shows a keycap 502 in its un-actuated state, while FIG. 5B shows a keycap 511 as it would appear when actuated by a user by touching the keycap with a finger or stylus.

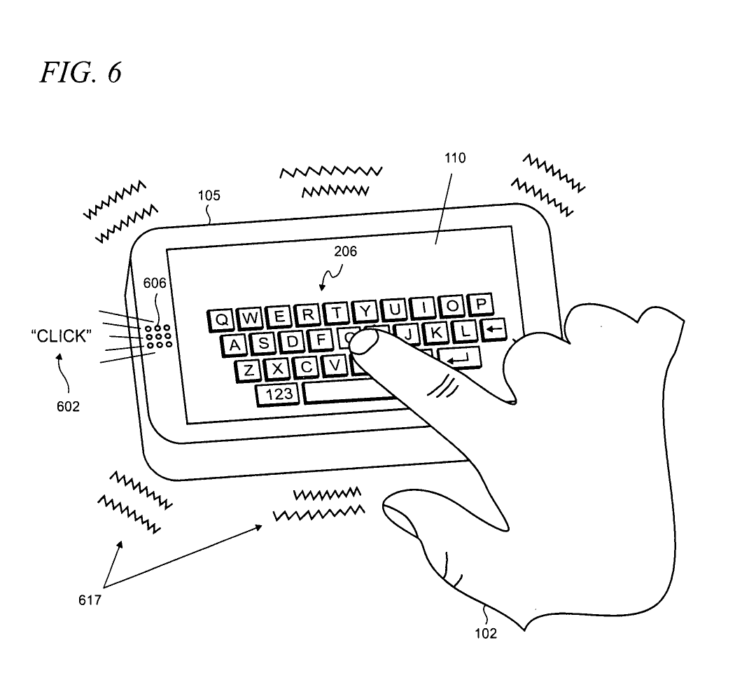

FIG. 6 shows the illustrative portable computing device 105 as configured to provide a combination of tactile, audio, and visual feedback to a user to provide the user 102 with the sensory illusion of interacting with a real 3-D key when a keycap in the virtual keyboard 206 is actuated using the device's touch screen 110. In some applications of the present 3-D object simulation, it is anticipated that utilization of the combination of all three feedback mechanisms (tactile, audio, and visual) will provide a highly satisfactory user experience while fully enabling blind input and/or touch typing on a device. However, in other scenarios, use of feedback singly or in various combinations of two may also provide satisfactory results depending on the requirements of a particular application. While FIG. 6 shows an illustrative example of a virtual keyboard, it is emphasized that the use of the feedback techniques described here are also applicable to icons used for control or navigation, and icons which may represent content that is stored or available on the device 105.

The visual feedback in this example includes the application of the visual effects shown in FIGS. 4A, 4B, 5A and 5B and described in the accompanying text to the keycaps in the virtual keyboard 206 to visually indicate to the user when a particular keycap is being pressed. As shown, the keys in the virtual keyboard 206 are arranged with drop shadows to make them appear to stand off from the surface of the touch screen 110. This drop-shadow effect is removed (or can be lessened) when a keycap is touched. In this example as shown, the user is pushing the “G” keycap.

The audio feedback will typically comprise the playing of an audio sample, such as a “click” (indicated by reference numeral 602 in FIG. 6), through a speaker 606 or external headset that may be coupled to the device 105 (not shown). The audio sample is arranged to simulate the sound of a real key being actuated in a physically-embodied keyboard. In alternative arrangements, the audio sample utilized may be configured as some arbitrary sound (such as a beep, jingle, tone, musical note, etc.) which does not simulate a particular physical action, or may be user selectable from a variety of such sounds. In all cases, the utilization of the audio sample provides auditory feedback to the user when a keycap is actuated.

The tactile feedback is arranged to simulate interaction with a real keycap through the application of motion to the device 105. Because the touch screen 110 is essentially rigid, motion of the device 105 is imparted to the user at the point of contact with the touch screen 110. In this example, the motion is vibratory, which is illustrated in FIG. 6 using the wavy lines 617.

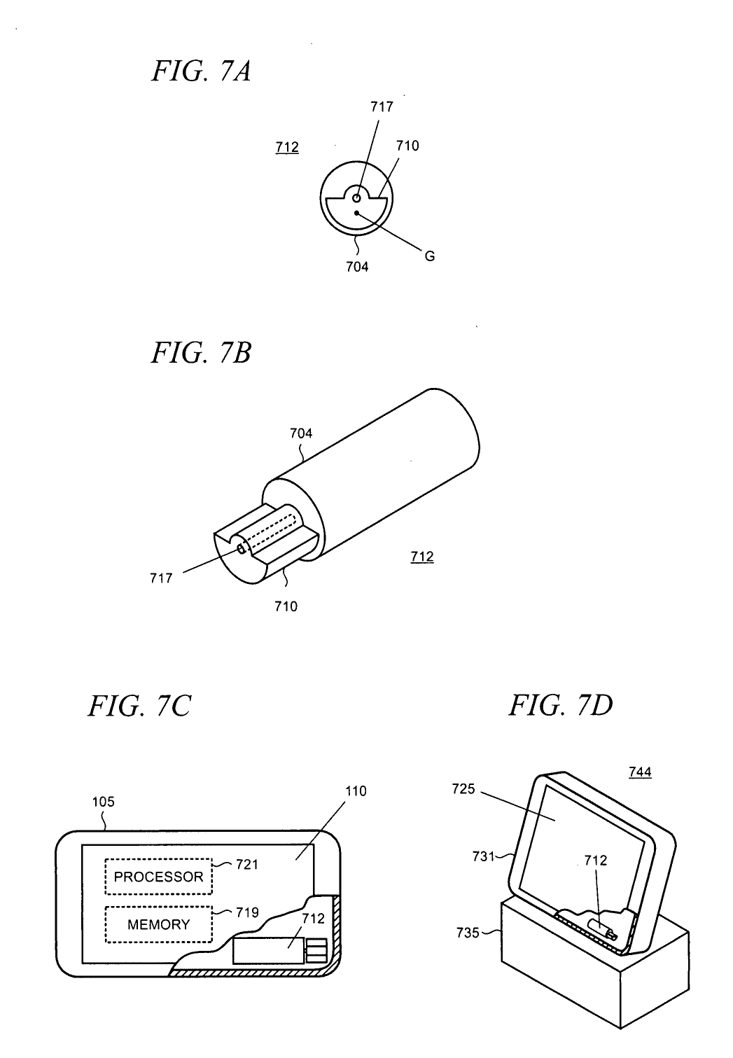

FIGS. 7A and 7B show respective front and orthogonal views of an illustrative vibration motor 704 and rotating eccentric weight 710 which comprise a vibration unit 712. Vibration unit 712 is used, in this illustrative example, to provide the vibratory motion used to implement the tactile feedback discussed above. In alternative embodiments, other types of motion actuators such as piezoelectric vibrators or motor-driven linear or rotary actuators may be used.

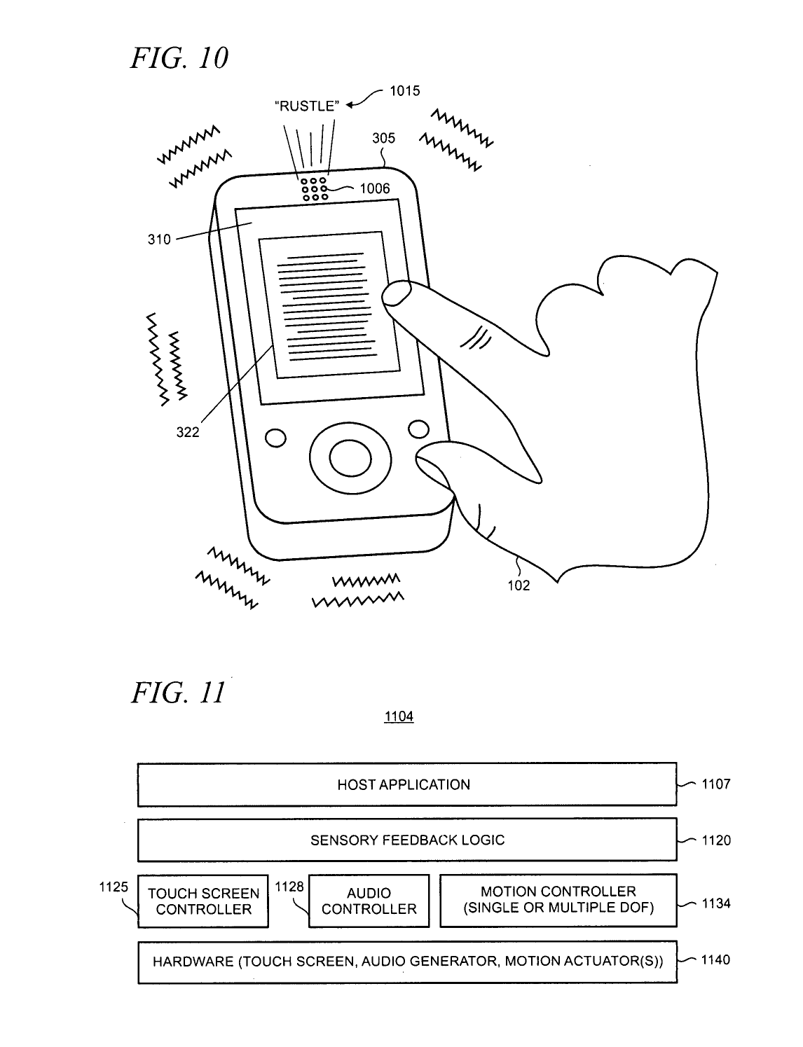

The vibration motor 704 in this example is a DC motor having a substantially cylindrical shape which is arranged to spin a shaft 717 to which the weight 710 is fixedly attached. Vibration motor 704 is further configured to operate to rotate the weight 710 in both forward and reverse directions. In some applications, the vibration motor 704 may also be arranged to operate at variable speeds. Operation of vibration motor 704 is typically controlled by the motion controller, application, and sensory feedback logic components described in the text accompanying FIG. 10 below.

Eccentric weight 710 is shaped asymmetrically with respect to the shaft 717 so that center of gravity (designated as “G” in FIG. 7A) is offset from the shaft. Accordingly, a centrifugal force is imparted to the shaft 717 that varies in direction as the weight rotates and increases in magnitude as the angular velocity of the shaft increases. In addition, a moment is applied to the vibration motor 704 that is opposite to the direction of rotation of the weight 710.

In portable device implementations, the vibration unit 712 is typically fixedly attached to an interior portion of the device, such as device 105 as shown in the top cutaway view of FIG. 7C. Such attachment facilitates the coupling of the forces from operation of the vibration unit 712 (i.e., the centrifugal force and moment) to the device 105 so that the device vibrates responsively to the application of a drive signal to the vibration unit 712.

Through application of an appropriate drive signal, variations in the operation of the vibration unit 712 can be implemented, including for example, direction of rotation, duty cycle, and rotation speed. Different operating modes can be expected to affect the motion of the device 105, including the direction, duration, and magnitude of the coupled vibration. In addition, while a single vibration unit is shown in FIG. 7C, in some applications of the present arrangement for 3-D object simulation, multiple vibration units may be fixedly mounted in different locations and orientations in the device 105. In this case, finer control over the direction and magnitude of the motion that is imparted to the device 105 may typically be implemented. It will be appreciated that multiple degrees of freedom of motion with varying levels of intensity can thus be achieved by operating the vibration motors singly and in combination using different drive signals. Accordingly, a variety of tactile effects may be implemented so that different sensory illusions may be achieved. Particularly when combined with the appropriate auditory and visual feedback, different 3-D geometries or textures including roughness, smoothness, stickiness, and the like can be effectively simulated.

Also shown in FIG. 7C in phantom view are a processor 719 and a memory 721 which are typically utilized to run the software and/or firmware that is used to implement the various features and functions supported by the device 105. While a single processor 719 is shown in FIG. 7C, in some implementations multiple processors may be utilized. Memory 721 may comprise volatile memory, non-volatile memory or a combination of the two.

In POS terminal or kiosk implementations, one or more vibration units configured to provide similar functionality to that provided by vibration unit 712 are fixedly attached to a touch screen that is configured to be movably coupled to the terminal. For example as shown in FIG. 7D, a touch screen 725 may be movably suspended in a housing 731, or movably attached to a base portion 735 of the POS terminal 744. In this way, the touch screen 725 can move to provide tactile feedback to the user while the POS terminal 744 itself remains stationary. The POS terminal 744 generally will also include one or more processors and memory (not shown).

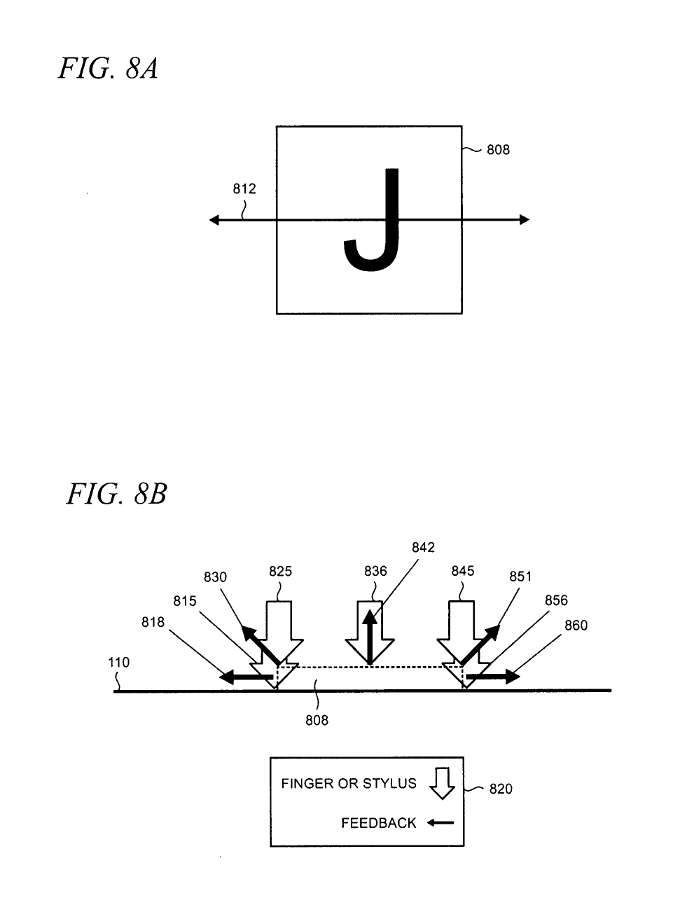

FIGS. 8A and 8B show respective top and side views of an illustrative virtual keycap 808. Tactile feedback is generated by operation of one or more vibration units (e.g., vibration unit 712 in FIG. 7) in response to touch so as to impart the perception to a user that the keycap has a depth dimension. In the illustrative example shown in FIGS. 8A and 8B, vibration is implemented so that a tactile feedback force profile can be provided using tactile feedback of varying magnitude, duration, and direction, typically by using multiple vibration units. However, in alternative implementations, a single vibration unit may be utilized in order to reduce the parts count and complexity of the device 105 and/or lower costs. In this alternative case, although fewer degrees of freedom of motion are available, a significant perception of 3-D is still typically achievable to a level that may be satisfactory for a particular application.

As indicated by the dotted-line profile in FIG. 8B, keycap 808 is provided with a tactile illusion of depth so that it feels as if it is standing off from the surface of the touch screen 110 when it is touched by the user. The user can slide or drag a finger or a stylus across the keycap 808 (as indicated by line 812 in FIG. 8A), for example from left to right. When the user's touch reaches the edge of the keycap 808, as indicated by white arrow 815, a tactile feedback force is applied in a substantially leftward direction, horizontally to the plane of the touch screen 110, as indicated by the black arrow 818. (As indicated in the legend 820, white arrows show the direction of a touch by a finger or stylus, and black arrows show the direction of the resulting tactile feedback force).

As the user slides from the edge to the virtual top of the keycap 808, as indicated by arrow 825, the direction of the tactile feedback force is substantially upward and to the left, as indicated by arrow 830, to impart the feeling of an edge of the keycap 808 to the user. Providing tactile feedback when the edge of the keycap 808 is touched can advantageously assist the user in locating the keycap in the virtual keyboard simply by touch, in a similar manner as with a real, physically-embodied keyboard.

As indicated by arrow 836, when the user touches a central (i.e., non-edge) portion of the keycap 808 with the intent to actuate the keycap, a tactile feedback force is directed substantially upwards, as shown by arrow 842. In this example, the magnitude of the force used to provide tactile feedback for the keycap actuation may be higher than that used to indicate the edge of the keycap to the user. That is, for example, the force of the vibration from device 105 can be more intense to indicate that the keycap has been actuated, while the force feedback provided to the user in locating the keycap is less. In addition, or alternatively, the duration of the feedback for the keycap actuation may be varied. Thus, it is possible to make the feedback distinctive so that the tactile cues to the user will enable the user to differentiate among functions. As the user glides his or her finger over the keycap, its edges will impact distinctive feedback so that the user can locate the keycap by feel, while a different sensation will typically be experienced when the user pushes on the keycap to actuate it.

Accordingly, a user will typically locate an object (e.g., button, icon, keycap, etc.) by touch via gliding a finger or stylus across the surface of the touch screen 110 without lifting. Such action can be expected to be intuitive since a similar gliding or “hovering” action is used when a user attempts to locate physically embodied buttons and objects on a device. A distinctive tactile cue is provided to indicate the location of the object on the touch screen 110 to the user. The user may then actuate the object, for example click a button, by switching from hovering to clicking. This may be accomplished is one of several alternative ways. In implementations where a pressure-sensitive touch screen is used, the user will typically apply more pressure to implement the button click. Alternatively, the user may lift his or her finger or stylus from the surface of the touch screen 110, typically briefly, and then tap the button to click it (for which a distinctive tactile cue may be provided to confirm the button click to the user). The lifting action enables the device 105 to differentiate between hovering and clicking to thereby interpret the user's tap as a button click. In implementations where a pressure-sensitive touch screen is not used, the lift and tap methodology will typically be utilized to differentiate between locating an object by touch and actuation of the object.

In an alternative arrangement, the force feedback provided to the user can vary according to the “state” of an icon or button. Here, it is recognized that to support a particular user experience or interface, an icon or button may be active, and hence able to be actuated or “clicked” by a user. In other cases, however, the icon or button may be disabled and thus unable to be actuated by the user. In the disabled state, it may be desirable to utilize a lesser magnitude of feedback (or no feedback at all), for example, in order to indicate that a particular button or icon is not “clickable” by the user.

As the user slides his or her finger further to the right of the keycap 808, as indicated by arrow 845, the location of the right edge is indicated to the user with a tactile feedback force that is upwards and to the right. This is shown by arrow 851. When the user's touch reaches the far edge of the keycap 808, as indicated by arrow 856, then a tactile feedback force is applied in a substantially rightward direction, horizontally to the plane of the touch screen 110, as indicated by arrow 860. It is noted that a similar tactile feedback force profile can be applied, in most cases, in situations where the user slides a finger or stylus from right to left on the keycap 808, as well as top to bottom, bottom to top, and from other directions.

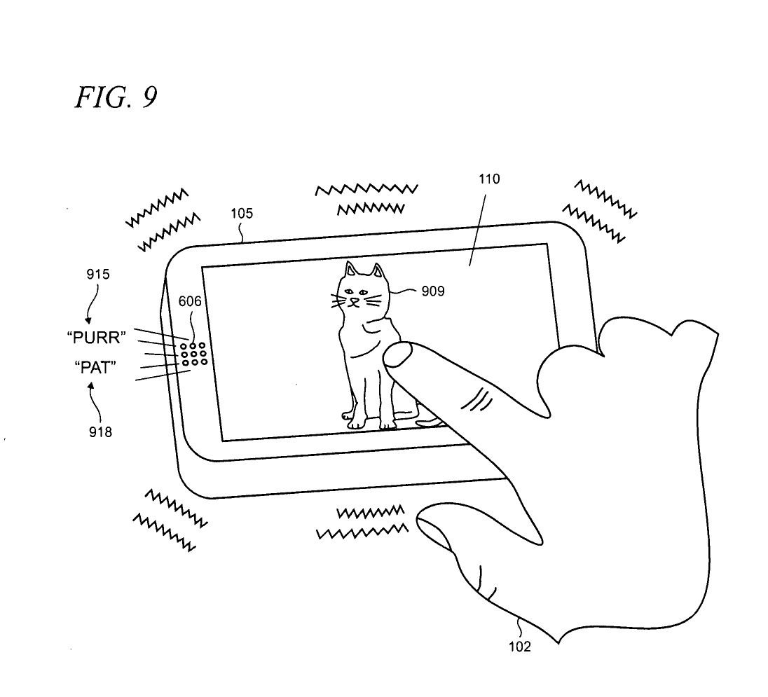

FIG. 9 shows an illustrative application of the present 3-D object simulation using audio, visual, and tactile feedback. In this example, an object used for implementing a “virtual pet,” such as a cat 909 as shown, is displayed by an application running on the device 105 on the touch screen 110. The virtual pet cat 909 is typically utilized as part of an entertainment or game scenario in which users interact with their virtual pets by grooming them, petting them, scratching them behind their ears, etc. Such interaction, in this example, is enhanced by applying the present techniques for 3-D object simulation. For example, when the user 102 pets the virtual pet cat (the object), the image of the cat 909 may be animated to show its furs being smoothed in response to the user's touch on the touch screen 110. An appropriate sound sample, which may include the purring of the cat, or the sound of fur smoothing or patting the cat (as respectively indicated by reference numerals 915 and 918) is rendered by the speaker 606 or coupled external headset (not shown).

In implementations in which the touch screen 110 is pressure-sensitive, the sensory feedback to the user can change responsively to changing pressure from the user on the touch screen. For example, the cat 909 might purr louder as the user 102 strokes the cat with more pressure on the touch screen 110.

In addition to the sound and visual feedback provided when the user 102 pets the cat 909, the device 105 is configured to provide tactile feedback such as vibration using one or more vibration units (e.g., vibration unit 712 shown in FIG. 7 and described in the accompanying text). By varying the direction, duration, and magnitude of the feedback force in response to the user's touch on the touch screen 110, various tactile sensations may be simulated including, for example, the feeling of stroking the cat 909, and/or having the cat 909 move in response to being touched by the user 102. While the audio, visual, and tactile feedback may be used singly or in various combinations of two, it is envisioned that the utilization of a combination of the three will often provide the most complete 3-D object simulation and the richest user experience in settings such as that provided by the illustrative entertainment or game application described above.

FIG. 10 shows another illustrative application of the present 3-D object simulation using audio, visual, and tactile feedback. In this example, device 305 is configured to enable the user 102 to browse among multiple pages in a document by touching the edge of page 322 on the touch screen 310 and then turning the page through a flick, or other motion, of the user's finger. For example, to move ahead to the next page in the document, the user 102 touches and then moves the right edge of page 322 from right to left (by dragging the user's finger across the touch screen 310) in a similar motion as turning the page in a real book. To go back to a previous page, the user 102 can touch the left edge of page 322 and move it to the right.

Tactile feedback is provided when the user 102 locates an edge of page 322 by touching the touch screen 310 in a similar manner as that described above in the text accompanying FIGS. 8A and 8B. Additional tactile feedback forces can be applied with device 305 as the virtual page is being turned, for example, to simulate the feeling the user 102 might experience when turning a real page (e.g., overcoming a small amount of air resistance, stiffness of the page and/or binding in the book, etc., as the page is turned).

The tactile feedback will typically be combined with audio and visual feedback in many applications. For example, an audio sample of the rustling of a page as it turns is played, as indicated by reference numeral 1015, over the speaker 1006 in the device 305, or a coupled external headset (not shown). However, as with the illustrative example shown in FIG. 6 and described in the accompanying text, alternative audio samples may be utilized including arbitrary sounds (such as a beep, jingle, tone, musical note, etc.) which do not simulate a particular physical action, or may be user selectable from a variety of such sounds. In all cases, the utilization of the audio sample provides auditory feedback when the user turns the virtual page 322.

The visual feedback utilized in the example shown in FIG. 10 may comprise an animation of the page 322 for which the animation motion is performed responsively to the motion of the user's finger or stylus. Thus, for example, page 322 may flip over, slide, or dissolve, etc., to reveal the next page or previous page in the document in response to the user's touch to the page 322 on the touch screen 310.

As in the illustrative example above, in implementations in which the touch screen 310 is pressure-sensitive, the sensory feedback to the user can change responsively to changing pressure on the touch screen from the user 102. For example, if the user 102 flicks the page more quickly or with more force (i.e., by applying more pressure to the touch screen 310), the page 322 will turn or slide more quickly, and the sound of the page being turned may be more intense or louder.

FIG. 11 is an illustrative architecture 1104 that shows the functional components that may be installed on a device to facilitate implementation of the present 3-D object simulation using audio, visual, and tactile feedback. The functional components are alternatively implementable using software, hardware, firmware, or various combinations of software, hardware, and firmware. For example, the functional components in the illustrative architecture 1104 may be created during runtime through execution of instructions stored in the memory 719 by the processor 721 shown in FIG. 7C.

A host application 1107 is typically utilized to provide a particular desired functionality such as the entertainment or game environment shown in FIG. 9 and described in the accompanying text. However, in some cases, the features and functions implemented by the host applications 1107 can alternatively be provided by the device's operating system or middleware. For example, file system operations and input through a virtual keyboard may be supported as basic operating system functions in some implementations.

A sensory feedback logic component 1120 is configured to expose a variety of feedback methods to the host application 1107 and functions as an intermediary between the host application and the hardware-specific controllers. These controllers include a touch screen controller 1125, audio controller 1128, and a motion controller 1134 which may typically be implemented as device drivers in software. Touch screen controller 1125, audio controller 1128, and motion controller 1134 interact respectively with the touch screen, audio generator, and one or more vibration units which are abstracted in a single hardware layer 1140 in FIG. 11. Among other functions, the touch screen controller 1125 is configured to capture data indicative of touch coordinates and/or pressure being applied to the touch screen and sending the captured data back to the sensory feedback logic component 1120, typically in the form of input events. The motion controller 1134 may be configured to interoperate with one or more vibration units to provide single or multiple degrees of freedom of motion as may be required to meet the needs of a particular implementation.

Thus, the sensory feedback logic component 1120 is arranged to receive a call for a specific sensory effect from the host application, such as the feeling of fur being smoothed in the example shown above in FIG. 10 along with the corresponding visual animation and sound effect. The sensory feedback logic component 1120 then formulates the appropriate commands for the hardware-specific controllers to thereby implement the desired sensory effect on the device. For example, to implement the multi-sensory effect of turning a page as described in the text accompanying FIG. 10, the sensory feedback logic component 1120 invokes the rendering of page animation on the touch screen and the playing of the sound of the page turning. In addition, a drive signal, or set of drive signals are generated to control the motion actuators such as vibration units. The drive signals will typically vary in amplitude, frequency, pulse shape, duration, etc., and be directed to a single vibration unit (or various combinations of vibration units in the implementations where multiple vibration units are utilized) to produce the desired tactile feedback.

While tactile feedback has been presented in which motion of the touch screen is utilized to provide distinctive sensory cues to the user, it is emphasized that other methods may also be employed in some scenarios. For example, an electro-static generator may be usable to provide a low-current electrical stimulation to the user's fingers to provide tactile feedback to replace or supplement the tactile sensation provided by the moving touch screen. Alternatively, an electro-magnet may be used which is selectively energized in response to user interaction to create a magnetic field about the touch screen. In this embodiment, a stylus having a permanent magnet, electro-magnet or ferromagnetic material in its tip is typically utilized to transfer the repulsive force generated through the operation of the magnetic field back to the user in order to provide the tactile feedback. Alternatively, such magnets may be incorporated into user-wearable items such as a prosthetic or glove to facilitate direct interaction with the touch screen without the use of a stylus.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing a multi-sensory experience to a user of a device, the device including a touch screen, the method comprising the steps of:
imparting motion to the touch screen, the motion being arranged for i) confirming a user action performed on the touch screen through tactile feedback to the user, ii) simulating interaction with an object as though the object has three dimensions, and iii) being imparted responsively to the user's touch to a representation of the object on the touch screen;
playing an audio sample that is associated with the interaction with the object, the audio sample confirming the user action through auditory feedback to the user; and
rendering a visual effect to the representation that is responsive to the interaction with the object, the visual effect confirming the user interaction through visual feedback to the user.

2. The method of claim 1 in which the motion comprises multiple degrees of freedom.

3. The method of claim 2 in which the visual effect comprises displaying the object on the touch screen so that the object appears to have a depth dimension.

4. The method of claim 3 in which the displaying comprises providing the object with a drop shadow, or rendering the object with perspective, or applying one or more colors to the object.

5. The method of claim 3 in which the visual effect further comprises an application of animation to the object.

6. The method of claim 1 including a further step of varying the motion imparted to the touch screen in response to a level of pressure that the user applies to the touch screen.

7. The method of claim 6 including a further step of varying the playing or varying the rendering in response to the level of pressure that the user applies to the touch screen.

8. A device for simulating 3-D interaction with an object displayed on a touch screen by providing a sensory feedback experience, comprising:
a touch screen arranged for receiving input indicative of a user action via touch and for displaying visual effects responsively to the user action;
one or more motion actuators arranged for imparting motion to the touch screen, the motion being arranged for i) confirming a user action performed on the touch screen through tactile feedback to the user, ii) simulating interaction with the object as though the object has three dimensions, and iii) being imparted responsively to the user's touch to a representation of the object on the touch screen;
a sound rendering device for playing an audio sample that is associated with the interaction with the object, the sound confirming the user action through auditory feedback to the user;
a memory for storing sensory feedback logic instructions; and
at least one processor coupled to the memory for executing the sensory feedback logic instructions, the sensory feedback logic instructions, when executed, implementing the sensory feedback experience for the user responsively to the user action, the sensory feedback experience including the tactile feedback, the auditory feedback, and the visual effects.

9. The device of claim 8 further including one or more structures for implementing functionality attendant to one of a mobile phone, personal digital assistant, smart phone, portable game device, ultra-mobile PC, personal media player, POS terminal, self-service kiosk, vehicle entertainment system, vehicle navigation system, vehicle subsystem controller, vehicle HVAC controller, medical instrument controller, industrial equipment controller, or ATM.

10. The device of claim 8 in which the one or more motion actuators are arranged to move the touch screen with multiple degrees of freedom of motion so that a distinctive motion which is associated with a specific 3-D simulation may be imparted to the touch screen.

11. The device of claim 10 in which the 3-D simulation is selected from one of geometry or texture.

12. The device of claim 10 in which the one or more motion actuators comprise vibration units which include a motor and rotating eccentric weight.

13. The device of claim 12 in which the motor is arranged to be driven at variable speed, or for variable duration, or in forward and reverse directions so that a plurality of different motions may be imparted to the touch screen each of the plurality of different motions being usable to simulate a different interaction.

14. The device of claim 10 in which the one or more motion actuators comprise electro-magnets that are configurable to produce a variable magnetic field or comprise electro-static generators that are configurable to produce an electro-static discharge.

15. The device of claim 10 in which the sound rendering device includes either an integrated speaker or an externally couplable headset.

16. A computer-readable medium containing instructions which, when executed by one or more processors disposed in an electronic device, implements an architecture for simulating an interactive 3-D environment for an object displayed on a touch screen associated with the device, the architecture comprising:
a sensory feedback logic component configured for implementing a sensory feedback experience to a user of the device comprising visual feedback, auditory feedback and tactile feedback in response to an input event to a touch screen;
a touch screen controller configured for receiving the input event from the touch screen and controlling rendering of a representation of the object onto the touch screen;
an audio controller configured for controlling playback of an audio sample to confirm the input event through the auditory feedback; and
a motion controller configured for controlling force applied by one or more motion actuators to the touch screen, the force comprising variable direction, duration, and magnitude to provide distinctive motion to the touch screen for each of a plurality of different input events.

17. The computer-readable medium of claim 16 further including a host application configured for generating the interactive 3-D environment.

18. The computer-readable medium of claim 17 further including a hardware abstraction layer comprising a touch screen, audio generator, and one or more motion actuators.

19. The computer-readable medium of claim 18 in which the input event comprises a touch by the user to locate the object displayed on the touch screen by feel.

20. The computer-readable medium of claim 19 in which the input event comprises a touch by the user to interact with the object displayed on the touch screen by feel.
